(19) United States
(12) Patent Application Publication
(10) Pub. No.: US 2011/0155161 A1
(43) Pub. Date: Jun. 30, 2011

(54) METHODS OF TREATING KERATINOUS MATERIAL, AND APPARATUS FOR IMPLEMENTING SUCH METHODS

(75) Inventor: Henri Samain, Bievres (FR)

(73) Assignee: L'OREAL, PARIS (FR)

(21) Appl. No.: 13/001,688

(22) PCT Filed: Jul. 10, 2009
(86) PCT No.: PCT/IB09/53013

§ 371 Date: Feb. 16, 2011

Related U.S. Application Data
(60) Provisional application No. 61/083,431, filed on Jul. 24, 2008.

(30) Foreign Application Priority Data
Jul. 10, 2008 (FR) 08 03953

(51) Int. Cl. A45D 44/00; A45D 34/04; A61Q 19/00

(52) U.S. Cl. 132/200; 401/137

(57) ABSTRACT

A non-therapeutic method of cosmetically treating human keratinous material, the method including
applying to said keratinous material a probe composition suitable for interacting in predefined manner with the keratinous material,
using an apparatus to detect automatically any interactions between the probe composition and the keratinous material, and
automatically performing cosmetic treatment on the keratinous material as a function of the manner in which the probe composition has interacted.

The present invention relates to methods of treating human keratinous material, and to apparatus for implementing such methods. The invention applies more particularly to cosmetic or dermatological treatment of keratinous material, e.g. the skin or the hair.

### BACKGROUND

It would be desirable to have means for achieving more effective treatment of the skin or other human keratinous material. Such surfaces present numerous non-uniformities, whether natural or resulting from accident. For example, the skin may present blemishes over small areas, or the scalp may present blemishes involving only some of the hair, for example meshes that have been dyed, or concerning part of the hair only, for example its tips.

The blemishes encountered may be microscopic, for example of size lying in the range about 5 micrometers (μm) to about 500 μm, or lying in the range 1 μm to about 500 μm. In general, people ignore such microscopic blemishes, wrongly, since these blemishes can sometimes develop and consequently lead to major defects.

A conventional method of remedying blemishes consists in treating an entire surface. This can lead to problems insofar as overall application can lead to effects that are unattractive, to overloading, or to reactions. Thus, it is common practice to limit the action of such treatment in order to limit these undesirable effects.

It is known to apply specific active agents to blemishes. For example, it is desired to develop active agents for untangling, specifically for use with damaged hair. In certain circumstances, particularly when the hair is non-uniform, such an approach is unsatisfactory. Damaged hair is indeed subjected to more treatment than hair that is not damaged, but the effect of the care product on the non-damaged hair can lead to a heavy or fatty effect that is not good for the overall beauty of the hair.

In certain circumstances, the user may be asked to apply the composition in particular locations only. Such application is possible if the user can detect the blemishes easily. This applies for example to marks or spots on the face. The user can see them in the mirror and apply the care product where the marks exist. Such an approach becomes difficult when the surface has numerous locations for treatment, e.g. multiple marks or multiple spots on the face. It becomes practically impossible when the surface is difficult to see, for example when the blemishes relate to the hair or when they are not visible, e.g. because they are located on the back or on the scalp.

It is also possible to use the services of a professional such as a beautician or a hairdresser, but that is not satisfactory if the treatment needs to be performed regularly.

Publication WO 2007/022095 A1 discloses a method of applying makeup in which an agent that modifies the reflectance of the skin is applied to the skin by using ink jet printer technology. In one embodiment, the device includes a scanner and an ink jet printer, and in a single pass over the skin it analyses the skin, identifies unattractive characteristics, calculates the improvements to be made, and applies the agent that modifies reflectance so as to obtain those improvements. For example, the device can give a softer appearance to the skin by identifying pale and dark points and by applying the reflectance-modifying agent so as to darken pale points using a predefined averaging technique. The device may include means for recognizing the treated zone, e.g. the cheek bone or the cheek so that the improvements made are specific to the zone being treated, e.g. making cheeks look rosy so as to give the appearance of a person in better health, or darkening zones under the cheek bones so as to make them less prominent. A colorant may be deposited on certain portions of the skin to make it more uniform and markers that fluoresce under ultraviolet illumination may be used to make it easier to recognize certain regions during treatment. In an example seeking to simulate tanning, an agent that modifies the spectral characteristics of the skin is applied so as to reduce contrast between pale and dark zones, darkening zones of the skin in selective manner, while causing certain details of the skin to disappear. In another element, pale zones around wrinkles are darkened but the hollow zones within wrinkles are not modified.

Publication WO 2004/090629 A2 discloses a method of printing on the skin.

U.S. Pat. No. 6,543,893 describes an ink jet printer suitable for being moved manually over the skin. The printer may have a screen for displaying images that are to be printed and a device that enables the image to be personalized, e.g. by adding text or other information.

U.S. Pat. No. 6,622,723 describes an applicator having an ink jet printer head.

Application US 2006/0098076 discloses a system for ink jet printing on the skin that includes means for positioning the face. The printer system is suitable for printing hairs on the eyebrows or for printing color on the cheeks for blending in with a brush.

Application WO 02/01499 A2 describes a method of applying makeup by means of a movable applicator head supported by an arm that is articulated so as to follow the three-dimensional shape of the zone being made up. The three-dimensional shape is acquired with the help of one or more cameras. A design selected by the user can be printed using an ink jet. The printing may serve to cover a pigment mark with the same color as the surrounding skin, after performing colorimetric analysis thereon.

Application DE 10153249 A1 describes a method of applying compositions on the skin by means of an ink jet printing technique. Printing may be performed using a handpiece held by the user. In a variant, the print head may move relative to the skin by moving a belt or a carriage on a rail that is itself movable on two slideways at its ends.

Publication JP 2006-297691 discloses a printer system for printing an image on the skin, the system being fitted with means that enable the color of the skin to be measured. The printer system takes account of the color of the skin in the image that is to be reproduced, the print head being provided with a photodetector. For example, for a dark skin, the quantity of ink is increased. In a variant, not only is the lightness of the skin taken into consideration but also its color when calculating the image for printing.

Publication GB 2 343 657 describes a portable ink jet printer suitable for printing a mark authorizing entry to a concert or a discotheque on the forearm or the hand of a person. The ink that is deposited may be visible, fluorescent, magnetic, phosphorescent, or photochromic.

Application WO 02/00189 A1 describes a method of applying a colored composition on the skin in which it is possible to select a blemish on an image of the zone for treatment, which image is obtained by means of a camera that also measures color. Image modification software makes it possible to correct a blemish in the zone for treatment, e.g. a depigmented zone, by outlining the zone with the help of a computer mouse and then printing on the corrected zone the color of the surrounding zone.

Publication WO 03/032370 discloses an ink jet printer that can be positioned manually on the skin in order to print a tattoo.

Publication US 2007/0114306 describes an electrostatic spray device for making up the skin.

U.S. Pat. No. 7,190,550 discloses an installation capable of printing on the skin, in particular on the skin of the face.

Numerous appliances are also known for printing on the nails, e.g. from U.S. Pat. Nos. 5,931,166 and 6,035,860.

EP 1 310 212 A1 discloses a method in which a drop of composition is applied to a zone of the skin, and then the extent of the surface of the skin that has come into contact with the composition is evaluated by means of an optical sensor such as a camera or a non-optical sensor. Processing may be carried out as a function of the results of the evaluation.

FR 2 603 183 describes an appliance for measuring characteristics of the skin and for indicating to the user whether or not a measured parameter is within a normal range, for example, by turning on a light-emitting diode (LED).

### SUMMARY

There exists a need to benefit from a solution enabling treatment to be targeted in a manner that is effective and without difficulty, even when the blemish(es) is/are not visible, and the invention seeks in particular to satisfy this need.

First exemplary embodiments of the invention provide a method of treating human keratinous material, in particular a method of cosmetic treatment, the method comprising:
applying on said keratinous material a probe composition that is suitable for interacting in predefined manner with the keratinous material; and
treating the keratinous material as a function of the manner in which the probe composition has interacted.

The treating of the keratinous material may take place automatically, with a possible request for a confirmation from the user before the treatment begins. The user may have to depress a button to authorize the treatment.

The probe composition may interact at one or more locations. This or these location(s) may be determined with the help of apparatus that detects the interaction automatically. Thus, in exemplary implementations of the invention, the method comprises using the apparatus to detect automatically any interaction between the probe composition and the keratinous material. For example, the apparatus may detect the or each location where the composition has interacted, or in a variant locations where the composition has not interacted.

The apparatus may warn the user about the presence of one or more blemishes and where appropriate it may specify which active agent(s) to use. The user may then cause them to be applied by the apparatus.

The probe composition may interact more or less rapidly with the keratinous material, and the location(s) where the composition has interacted may be detected after waiting for a certain length of time, where necessary.

Preferably, the method is implemented by means of apparatus that performs detection and treatment during one or more passes of the apparatus over the keratinous material. By way of example, detection and treatment may take place in a single pass of the apparatus over the keratinous material. The apparatus may be held in the hand.

The interaction of the probe composition with the keratinous material may be invisible under visible light. The interaction of the composition with the keratinous material may be accompanied for example by the appearance of fluorescence that is detectable under ultraviolet (UV) or infrared (IR) light. The method may thus comprise illuminating the zone where the probe composition has been applied with UV and IR light, so as to detect fluorescence, if any.

The interaction may be accompanied by a change in the surface appearance of the keratinous material, e.g. the appearance of roughness and/or a change in the optical properties of the surface, e.g. a change in color, in gloss, or in reflectance.

The probe composition may interact chemically with the keratinous material. This interaction may be superficial only, remaining confined to the surface layers of the epidermis, and in particular it may be confined to the stratum corneum. The probe composition need not have any therapeutic or preventative action on the keratinous material.

The spatial resolution of the detection system may be better than 1 centimeter (cm), in at least one direction.

The invention enables treatment to be targeted even if the blemishes are invisible or hard to see, e.g. because they do not present a specific color or because they present no contrast or are small in size, e.g. being microscopic. In various exemplary embodiments of the invention, the apparatus may serve to detect micro-wrinkles, local oxygenation blemishes, or infectious skin problems.

The invention may enable a treatment composition to be applied, e.g. a care product or makeup, at the exact location of a blemish as detected by the apparatus, thereby enabling the quantity of treatment composition that is used to be kept small, e.g. by limiting application to only those locations where blemishes exist.

The invention makes it possible to use active agents that are expensive since the quantity of agent that is wasted is reduced. The invention thus makes it possible to use active agents that are powerful, since the quantity applied is reduced and the side effects are therefore diminished. By way of example, the invention makes it possible to use active agent producing biological effects that are otherwise difficult to use, e.g. derivatives of resorcin or active agents having physical or chemical effects such as ozone.

The invention makes it possible not to overlook blemishes. This may be an advantage with blemishes that might propagate, for example micro-infections or the external presence of germs.

The invention makes it possible to treat blemishes for the length of time needed. It is often difficult to know in advance how many applications need to be applied. The invention makes it possible to apply as many applications as necessary, but no more, by automatic prior detection of any defect(s) for treatment, before applying the treatment.

It is possible for skin to present blemishes, which although of the same kind, might be at different stages of progress. Thus, treatment durations or quantities of active agent for application are not necessarily identical. With conventional methods, after performing treatment for a certain length of time, the user may see that some of the blemishes have been treated and have disappeared, while other blemishes remain present. Under such circumstances, the user generally does not know whether treatment should be continued or stopped. Similarly, after treatment has been continuing for a certain length of time, the user may have caused the main blemishes to disappear and may stop treatment. However, at this stage, blemishes that are less visible need not necessarily have been treated. The invention can enable such problems to be resolved since the apparatus is capable of automatically selecting which blemishes need to continue being treated.

The invention also makes it possible to act in advance of blemishes arriving. The apparatus enables skin to be treated long before blemishes are visually noticeable. The invention can enable blemishes to be treated in preventative manner and can prevent them from appearing.

Skin and other keratinous materials may present a plurality of blemishes that require treatment using different active agents. It is difficult to deposit a plurality of active agents in localized manner with a conventional approach. It is sometimes possible to use a finger or an applicator to deposit a composition containing a plurality of active agents, however the choice of active agent is often restricted because of incompatibilities between active agents and because of combined or cumulative effects that this approach can cause. The invention enables this problem to be handled by enabling active agents to be applied selectively and accurately in one or more passes.

The apparatus may contain at least two active agents and may apply them at the locations of blemishes. The apparatus may apply these active agents in a single pass, where appropriate.

In an exemplary implementation of the invention, the method comprises applying the probe composition at least one predefined location on the keratinous material, e.g. the skin, and as a function of the manner in which the composition interacts, in applying one or more active agents to the body or the face in locations other than those where the probe composition has been applied. For example, the probe composition may be applied to the bust or to the forehead, which are areas that are often more sensitive than the remainder of the body to the effects of the sun or of sebum. Application performed away from the zone that has been subjected to detection can serve to reveal future blemishes and thus to perform preventative treatment.

In an exemplary implementation of the invention, the method comprises analyzing the skin of a different person prior to applying one or more active agents. Thus, the method may comprise applying the probe composition on a person living in the same work, pollution, or lighting environment, or on an older person having the same type of skin, e.g. someone in the same family, e.g. a brother, a sister, or a parent. The way in which the skin of an older relative develops often prefigures, at least to some extent, the way in which the skin of a younger person in the family is going to develop, and the invention may be used to begin treatment early. For example, it is possible to use the method to detect wrinkles, dilated pores, marks, sagging muscles, or drying of the skin.

The invention may be useful with people having little ability to communicate, for example children and babies, people having difficulty in speaking, people who are unconscious, or people who have lost all or some of their sensibility. For example, when such persons are subject to irritation of the skin, it is often difficult to understand what they feel, and the invention can provide significant assistance in such situations by enabling suitable active agents to be applied.

### Probe Composition

The probe composition may be suitable for showing up an established or potential blemish, either by interacting therewith, or by interacting with keratinous material where the blemish does not exist.

The term “blemish” in the meaning of the present invention should be understood as comprising any portion of an appearance or a state that needs to be improved. This may be an infection, an inflammation, small recesses (pores, wrinkles, . . . ) or projections (edges of scars, spots, . . . ), colored marks on the surface, internal colored marks (small blood vessels), depigmentations, zones having a dull appearance, zones having a shiny appearance, zones that are rough, or zones that are smooth. A blemish may be constituted by the presence or absence of hairs, of squama, of dandruff, or of fatty bodies. With hair, blemishes may comprise split ends.

A blemish may be the result of defective biological functioning, a lack of uniformity in biological function, e.g. a zone in which the activity of melanocytes is stronger, a barrier quality defect, e.g. a weakened barrier that has become too thick, a mechanical weakness, too much elasticity, a difference in porosity, the presence of external biological agent, such as for example bacteria, yeasts, or parasites, the presence of pollutants, e.g. certain metals or agents produced by the biological activity of parasites, e.g. acarid excrement or allergenic proteins from animals, the presence or remanents or derivatives of compositions previously applied, e.g. leftover coloring.

The probe composition may include one or more optically detectable compounds and/or one or more compounds that present at least one function that is detectable by spectrometry (nuclear magnetic resonance (NMR), Raman, IR, electron paramagnetic resonance (EPR)), or detectable in an electric or a magnetic field or by other methods, such as sound detection. The probe composition may include particles that are detectable in a magnetic or an electric field. Optical detection may be performed at some particular magnification, where appropriate, for example magnification of at least ×2, ×5, ×10, ×50, ×100, or ×500, or even more.

The probe composition may include one or more probe compounds, which may optionally be in solution or dispersed in an aqueous or an organic medium that is cosmetically or dermatologically acceptable.

Preferably, when using a plurality of optically-detectable probe compounds, the probe compounds are selected to be capable of being detected independently of one another. For example, they may have detection wavelengths that are spaced apart from one another by at least 10 nanometers (nm) and preferably the absorption peaks of these compounds are narrow, e.g. with a width at half-height of less than 100 nm.

Interaction with Modification of Optical Properties

The probe composition may include a probe compound, e.g. a compound that is colorless or that presents little color, and that as a result of a covalent or physiochemical reaction with a molecule of keratinous material, e.g. of the skin, or with an exogenous molecule, gives rise to the appearance of an absorption band in the visible, UV, or IR spectrum.

The probe composition may also reveal a blemish by shifting an absorption zone. Under such circumstances, the probe compound may include one or more probe compounds, and detection may be performed by searching for the appearance of a new form of the probe compound, e.g. absorption shifted through at least 10 nm and/or the disappearance of the original form of the probe compound.

The reaction(s) of keratinous material with the probe compound(s) may be chemical or physicochemical, and the probe composition may include for example a compound of the ninhydrin or docosahexaenoic acid (DHA) type that reacts with certain organic functions to go from being colorless to colored.

The probe composition may also be selected to reveal a blemish by becoming fluorescent or having fluorescence with an absorption band that is offset and/or an emission band that is offset.

By way of example, the probe composition may include a compound of the ABDF type (ABDF=7-fluorobenzo-2-oxa-1,3 diazole-4-sulfonamide), which, on reacting with certain nucleophilic sites leads to the appearance of fluorescence of a green color that can be detected by emission under UV irradiation, or aminophenoxazone maleimide (APM) that reveals the presence of cysteine residues in proteins.

The probe composition may include a compound of the type described in the article by H. Katerinopoulos published in the journal Current Medicinal Chemistry, 2002, 9, pp. 275-306, that leads to a change in absorption as the result of complexing with a salt of calcium, zinc, or sodium.

The probe composition may also include a compound having an anionic or a polyanionic complexing function attached to an aromatic chromophore, e.g.:

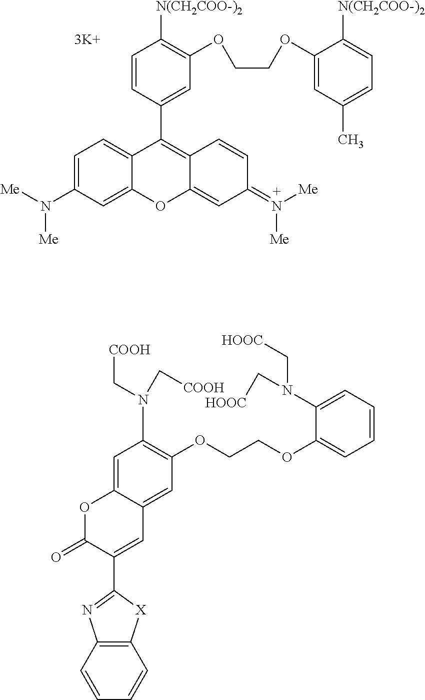

or a compound having an ether crown complexing function attached to an aromatic chromophore, e.g.:

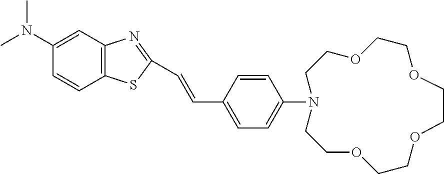

The probe composition may include a pH-probe compound such as a colored indicator for example, of form that varies as a function of the local concentration of H+ ions.

The probe composition may include a temperature-sensitive compound, of color that changes for a small temperature difference, or a photosensitive compound.

For example, the method may include applying a probe composition to hair, where the probe composition includes a photosensitive compound, and then illuminating the hair, e.g. in transillumination, so as to cause color to appear where hairs are white, pale, or bleached, and therefore allow light to pass through them.

The probe composition may react with keratinous material by way of reactions that involve a plurality of steps, with only one of them, for example, leading to the appearance of a detectable compound.

For example, the method of the invention may include applying a reducing agent that serves to cause thiol functions to appear on sulfur-rich proteins, applying a catalyst, e.g. Mn²⁺, capable of bonding specifically on the thiol sites that are created, and then applying a compound that leads to an oxidative color reaction based on a dye precursor, e.g. based on amino-pyrazolopyridine and oxygenated water. Color then appears preferentially at locations that include sulfur-rich proteins.

The probe composition may also be adapted to reveal inorganic compounds, metals, or ions, small organic molecules, proteins, deoxyribonucleic acid (DNA), and/or changes in the shape of proteins or of DNA.

Other compounds that may be involved in formulating the probe composition are mentioned in Topics in fluorescence spectroscopy Vol. 4: probe design and chemical sensing, by Joseph R. Lakowski, published by Lavoisier (1994).

It is possible to use a probe composition that, on coming into contact with the blemish, passes from a state in which it diffuses light, e.g. a whitish state, to a state in which it is transparent, or vice versa. Thus, the probe composition may comprise an emulsion that goes from white to transparent on skin that absorbs water or fatty bodies very quickly and remains white on skin that does not absorb.

The probe composition may comprise an emulsion of at least one polymer, such as a latex, or a pseudo-latex.

The probe composition may include a compound that changes, e.g. as a function of temperature, from an amorphous form to a crystalline form, or vice versa, e.g. a fatty alcohol.

The probe composition may serve to reveal the planeness of a surface, e.g. the skin or the fingernails.

It is possible to apply on keratinous material, e.g. the skin, a composition that has high reflecting power, e.g. greater than 50%, e.g. a nanodispersion of metal particles, e.g. silver particles, e.g. of mean size lying in the range 10 nm to 70 nm, or in a variant a sol-gel based on titanium oxide or a dispersion of flakes having high reflecting power. Thereafter, a detector system that is responsive to reflected light may be placed facing the keratinous material. On scanning the skin, the detection system identifies zones where reflecting power is small, e.g. corresponding to portions in relief such as wrinkles or spots. In an exemplary implementation of the invention, the method further includes the step consists in imaging the keratinous material, e.g. on a linear or matrix sensor, e.g. of the charge-coupled device (CCD), complementary metal oxide on silicon (CMOS), or electron-multiplying CCD (EMCCD) type. This makes it possible to detect blemishes in relief and also to determine the nature and the amplitude of such blemishes.

In a variant implementation of the invention, it is also possible to apply a probe composition and to analyze diffuse light and the ratio of specular light divided by diffuse light.

Interaction with Absorption

The probe composition may include a probe compound, e.g. a compound that is detectable optically since it carries a chromophore, for example, and that depending on whether a blemish is present or absent reacts to a greater or lesser extent with the keratinous material or becomes absorbed to a greater or lesser extent by the skin or some other keratinous material, after which measuring the degree of absorption enables any blemishes to be located.

Revealing blemishes by absorption may rely on the fact that because of interactions with the skin, the probe compound attaches thereto. As a result, on detecting it, and if absorption is preferential on a blemish, it can be seen whether the keratinous material has blemishes in the zone under consideration.

The level to which the probe compound is absorbed may depend for example on the existence of physicochemical interactions, e.g. ionic bonds or hydrogen bonds.

The probe composition may include one or more compounds including nucleoside bases, made up of chains of pieces of DNA, ribonucleic acid (RNA), or derivatives thereof, carrying a detectable function such as a function that is colored or fluorescent. Such compounds bond physicochemically with strands of DNA or RNA that are naturally present in the skin.

The probe composition may include a probe compound that includes an antibody portion, e.g. made by bioengineering, and carrying a detectable function, e.g. a function that is colored or fluorescent. By way of example, it is possible to use a probe composition that includes biotin as its antibody portion that bonds strongly in the presence of avidin.

The probe composition may include a probe compound based on an HNS function that reacts with primary or secondary amines, thus enabling certain proteins to be detected.

The probe composition may have one or more solubilizing functions.

For example, the probe composition may contain the following compounds from the supplier LI-COR Bioscience:
For detection around 800 nm

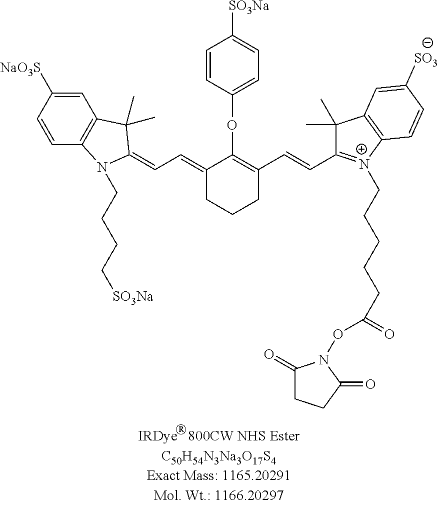

For detection around 700 nm

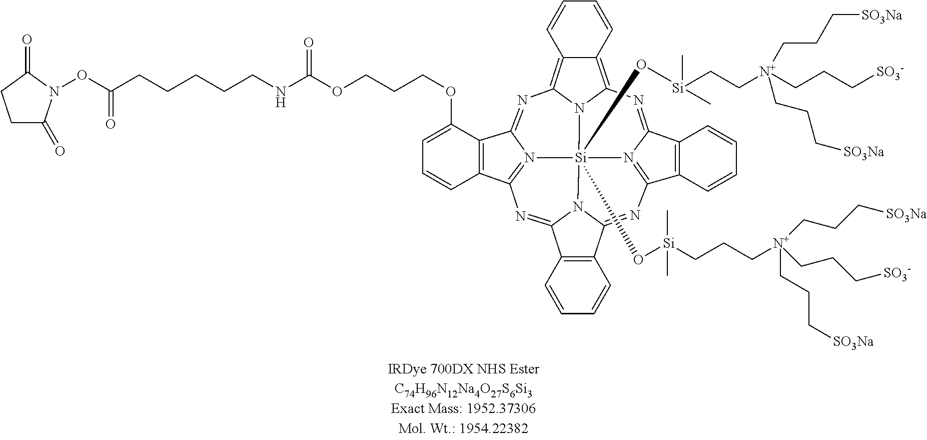

Probing by absorption may be performed by attaching to a biochemical receiver, and in particular a receiver located on the surface of cells.

In particular, the probe composition may include a probe compound capable of reacting with a receiver, which compound may for example be fluorescent. Attachment may be obtained for example by chemical reaction with compounds carrying NHS functions, succinimide, . . . .

For example, a fluorescent compound known as “IRDye 800CW-EGF” from the supplier LI-COR Biosciences may be used. That compound has an amino acid series (54), a recombinant epidermal growth factor and a fluorescent function covalently bonded together and detectable in the near IR. The compound fixes to the epidermal growth function receivers (EGF-R), which are known to be specially expressed in zones of intensive activity. Detection takes place by illumination and reading in the near infrared, e.g. around 800 nm.

The probe composition may include a probe compound that may be in the form of free molecules or particles, e.g. nanometric or microscopic particles, e.g. particles that are colored or fluorescent, e.g. pigments or semiconductor compounds such as quantum dots.

Before or after application of the probe composition, it is possible to perform treatment such as rinsing and/or application of a surface-active agent. Thus, by way of example, it is possible to apply an anionic colorant to reveal a surface that is charged or porous, e.g. a food color, e.g. based on a sulfonic function, or a cationic colorant, e.g. an arylazoimidazolium colorant or coloring or fluorescent agents of large molecular weight, e.g. greater than 250 grams per mole (g/mol), e.g. a derivative of porphyrin. Thereafter, rinsing is performed, e.g. using clean water, or washing with an aqueous solution based on a surface-active agent. The rinsing or washing serves to eliminate colored or fluorescent molecules that do not interact strongly with sites on the skin so that the only colored or fluorescent molecules that remain are those that have interacted strongly. Anionic and cationic colorants and coloring or fluorescent agents reveal portions that have become hydrophilic and that may require special attention. Coloring or fluorescent agents of large molecular mass reveal portions that become porous or thick, for example.

The interaction of the probe composition with the keratinous material may involve selective absorption on a blemish followed by a reaction for causing a detectable characteristic to appear, such as a color or fluorescence, for example. By way of example, it is possible to apply a strongly-charged cationic polymer such as an ionene. Thereafter, rinsing is performed so that only those polymers that have interacted strongly with the anionic zones remain on the skin. Thereafter, an anionic colorant is applied, e.g. a food color based on a sulfonic function, thus serving to reveal zones of the skin in which the extreme surface is anionic, and therefore degraded.

### Interaction by Mechanical Attachment

It is possible to deposit on keratinous material, e.g. the skin, a probe composition that interacts with keratinous material by attaching more or less strongly depending on the zone. Thus, after subjecting the keratinous material to some mechanical action, e.g. rubbing, dusting, blowing on, or applying suction nearby, the probe composition will remain present to a greater or lesser extent depending on the zone, and blemishes can thus be detected.

For example, the probe composition may comprise a colored or fluorescent compound or an active agent that is detectable by rubbing. The compound may be in particulate form in the form of a solution that can give rise to particles in one or more actions, e.g. a salt in solution, a salt that is not very soluble, or a sol-gel composition. Preferably, the size of the particles is about 100 nm to 1000 μm, preferably in the range 200 nm to 100 μm. The particle may be spherical or non-spherical, for example they may be in the form of flakes.

By mechanical attachment to the skin, the probe composition may be used to detect zones that are fatty or moist, recesses such as dilated pores, or ridges or bumps. In the particular circumstance of bumps, detection may take account of the fact that the particles do not reveal the tops of bumps, but only their bases.

With hair, the presence of particles in the probe composition may serve for example to detect the edges of flaking. The particle used may be of size lying for example in the range 100 nm to 200 nm, better in the range 125 nm to 175 nm, e.g. about 150 nm, the particles being spherical, for example.

The probe composition may include adhesive particles, non-adhesive particles in association with adhesive particles, or particles contained in an adhesive formulation or of tacky rheology.

The probe composition may be applied initially by applying an adhesive base to the keratinous material and subsequently applying particles that adhere to the adhesive base. The presence of these particles can be detected optically or mechanically, e.g. by rubbing, by measuring shape, or by measuring the noise generated by rubbing. The presence of particles may also be detected magnetically if the particles are themselves magnetic, e.g. because they contain iron or Fe₃O₄, for example.

### Interaction by Penetration

It is also possible to apply a probe composition containing at least one probe compound capable of penetrating to a greater or lesser extent into the skin or the hair or other human keratinous materials. Thus, although there is no absorption of the probe composition on a particular function, differences can be observed depending on whether the keratinous material does or does not absorb the probe composition.

By way of example, the probe composition that is neutral, amphoteric, or made up of particles, e.g. suitable for revealing the integrity of the protective membranes or layers, such as the cuticle or the stratum corneum. The term “integrity of the protective membranes or layers” is used to refer to their isolation function preventing internal elements from escaping.

It is possible to track the quantity of probe compounds that have managed to penetrate, e.g. by an optical detection system.

By way of example, the method may include applying a reducing solution on the hair, the solution being based on thioglycolic acid for example, in particular 0.5 M thioglycolic acid at pH 8.5. After waiting for a certain length of time, e.g. 4 minutes, the hair is dried and then a composition containing a fluorescent probe compound, e.g. ABDF (ABDF=7-fluorobenzo-2-oxa-1,3 diazole-4-sulfonamide) is applied. The hair is illuminated in UV light, e.g. at a wavelength of 360 nm, and fluorescent emission can be detected on a microscopic scale, e.g. with magnification of ×500, which emission takes place mainly at locations where hairs present blemishes such as microcuts or longitudinal breaks.

The probe composition may include a probe compound that is optically detectable, e.g. being colored, in a dry medium or in a solvent that does not allow penetration. The method may comprise applying the probe compound and then applying a solvent capable of eluting the probe composition in the keratinous material on which the probe compound has been applied. Penetration is then proportional to the extent to which the colored compound has disappeared. This approach is particularly advantageous for black skins or for colored zones of Caucasian or Asiatic skins. It is thus possible to deposit a solution of acetone containing a cationic colorant. After the acetone has dried, a composition is applied containing 80% water and 20% benzylic alcohol. After waiting for a few minutes any zones that have been made fragile or more porous will have absorbed more colorant. The skin is then padded with cotton fabric. Zones that have absorbed most colorants leave little marking on the cotton fabric.

### Interaction by Modifying or Varying Rheological or Adhesive Properties

It is possible to use a probe composition having rheology that varies on coming into contact with a blemish and having adhesive properties or friction properties that vary on coming into contact with a blemish. For example it is possible to use a gel based on Carbopol® (polymers of cross-linked acrylic acid) of rheology that drops in the presence of acid compounds.

### Biochemical Interaction

It is possible to reveal a blemish by biochemical activity, in particular natural biochemical activity of the skin or of bulbs of the hair.

Thus, it is possible to apply a probe compound that is metabolized by these natural chemical systems.

The probe composition may involve at least one reaction present in cells of the skin, for example an enzyme reaction and in particular one or more proteases, catalases, peroxidases, laccases, oxidases, tyrosinases, cyclooxidases, lipases, transamidases, transaminases, and/or reductases.

The probe composition may also respond to reactions involving the treatment (duplication, transcription, repair, . . . ) of DNA, RNA, proteins, or reactions involving catabolism and metabolism of sugars, lipids, and transfers of energy (adenoside-tri-phosphate (ATP), . . . ) and/or oxidation transfers (cytochrome C, . . . ).

The probe composition may also react with compounds produced by biological activity, either of the skin or of organisms that are present on the skin, e.g. the presence of oxygen, of ATP, of certain strands of DNA or of RNA, of certain proteins (proteases, laccases, nitroreductases, peroxidases, catalases, for example), or certain vitamins (e.g. vitamin D).

The probe composition may also react with compounds that are transformed by biological activity or that are transported by biological action.

Thus, in an exemplary implementation of the invention, a substance is ingested, and after circulation in the body, it is to be found in the skin or the hair.

For example, a perfluorinated organic solvent is ingested or breathed in or injected. The solvent passes through the vessels and through the skin, specifically where irrigation by the blood is the strongest. This serves to reveal the state of circulation by detecting the presence and the quantity of the perfluorinated compound on the skin.

The probe composition may pass through cell membranes. For example, a compound may be placed on the skin that presents ligating power, but having ligating functions that have been masked. This relatively neutral compound penetrates into cells since it is not stopped by cell membranes. Once the blemish has penetrated, enzymes (e.g. esterases in particular) cut the functions protecting the ligating functions and the compound becomes reactive and can react with specific molecules in cells.

As an example, it is possible to use molecules carrying anionic functions and an aromatic chromophore. By virtue of their anionic functions, e.g. four functions per molecule, these molecules can bond with ions, e.g. with calcium ions. In complexing contact, the chromophore changes absorption band, thus enabling it to be detected.

The anionic functions may be protected by protection functions, e.g. acetoxymethyls. Once the molecules have entered into cells, the protection functions are cut by proteases, thereby releasing the anionic functions enabling liganding and detection.

The probe composition may include living cells that serve to reveal certain defects. For example, the method may include a step consisting in depositing a culture medium on the skin, which culture medium is favorable to developing certain germs. Detection can then be performed by viewing, by detecting waste products, or by revealing enzymes, e.g. proteases.

It is possible to apply a probe composition having a probe compound that includes a portion, e.g. a small peptide, that is recognizable by an enzyme, e.g. a protease, and that also includes two functions, namely a fluorescent function and a quencher portion.

The compound may be made by reacting the peptide with two molecules:
IRDyes-QC-1 that reacts with the peptide on one of its free amine functions when using the protocol proposed by the supplier LI-COR Biosciences; and
IRDyes CW-NHS that also reacts with the peptide on one the free amine functions.

Because both portions are situated in the same molecule, the quencher portion prevents the fluorescent portion being active by a phenomenon known as fluorescence resonance energy transfer (FRET). A blemish that has abnormal protease activity cuts the probe compound in two, e.g. by hydrolysis. Thus, since the two functions are no longer in the same molecule, activity returns to the fluorescent portion and the peptide becomes detectable.

Such a probe composition is applied to the skin. The apparatus detects fluorescence by exciting it, e.g. by means of an IR LED, and by analyzing the IR emission. Blemishes may be corrected by applying a protease inhibitor, for example.

### Application Conditions for the Probe Composition

The probe composition may be in the form of a composition for spreading, transferring, dusting, spraying, ingesting, or inhaling. The probe composition may be presented in liquid, solid, or powder form, it may be dispersible or gelled. The probe composition need not have any therapeutic power, and by way of example it may interact with the surface layers only of the epidermis.

Application may require pre- or post-treatment, e.g. cleaning of the keratinous material and/or drying of the probe composition or it may require mechanical treatment such as suction or exfoliation or treatment for modifying surface states, such as peeling, or a change in hydrophilic, or hydrophobic, or surface-tension characteristics.

Detection may require a certain amount of waiting time after application, e.g. lying in the range 1 second (s) to a few days.

Application of the probe composition may be combined with physical or physicochemical treatment such as applying heat, ultrasound, solvents, or irradiation. Such treatment may serve to accelerate the action of the probe composition or to accelerate its penetration. It is also possible to associate application of the probe composition with treatment or with physical or physicochemical conditions serving to protect or temporarily prevent the probe from acting, for example low temperature or darkness.

The probe composition may be applied as a cosmetic, e.g. an antiperspirant, a care product, a sunscreen, an after-sun milk, makeup, makeup remover, a washing composition, a composition for the hair such as a shampoo, a dye, a permanent wave composition, a hairdressing composition, or a relaxer.

The probe composition may also be deposited by means of dressings, patches, or garments.

Where appropriate, the probe composition may be applied using the same apparatus as that which is used for detecting and/or treating blemishes, by the same application system or by different means.

### DRAWINGS

In the accompanying drawings:

FIG. 1 is a block diagram of an example of apparatus made in accordance with the invention;

FIG. 2 is a diagrammatic view of an example handpiece;

FIG. 3 is a view analogous to FIG. 2 showing a variant embodiment;

FIG. 4 is a diagrammatic and fragmentary view of an example of an application system and a detection system;

FIG. 5 is a diagrammatic and fragmentary view of an example of a detection system;

FIG. 6 is an electronic schematic of an example of the apparatus;

FIG. 7 is a view analogous to FIG. 5 showing a variant implementation of the invention;

FIG. 8 is a view analogous to FIG. 6 showing a variant apparatus; and

FIG. 9 is a diagrammatic and fragmentary view of another example of detection and application systems.

### APPARATUS

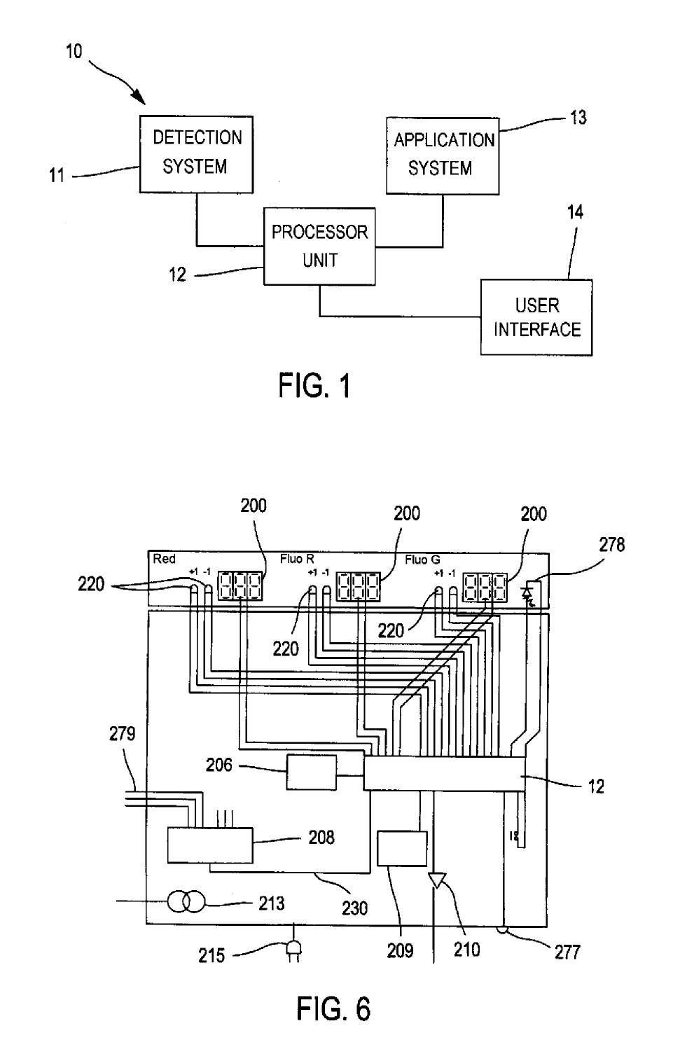

The method of the invention may be implemented with the help of an apparatus 10 provided, as shown in FIG. 1, with a detection system 11 and a processor unit 12 capable of processing the information collected by the detection system 11.

The apparatus 10 may also include an application system 13 controlled by the processor unit 12 and an interface 14.

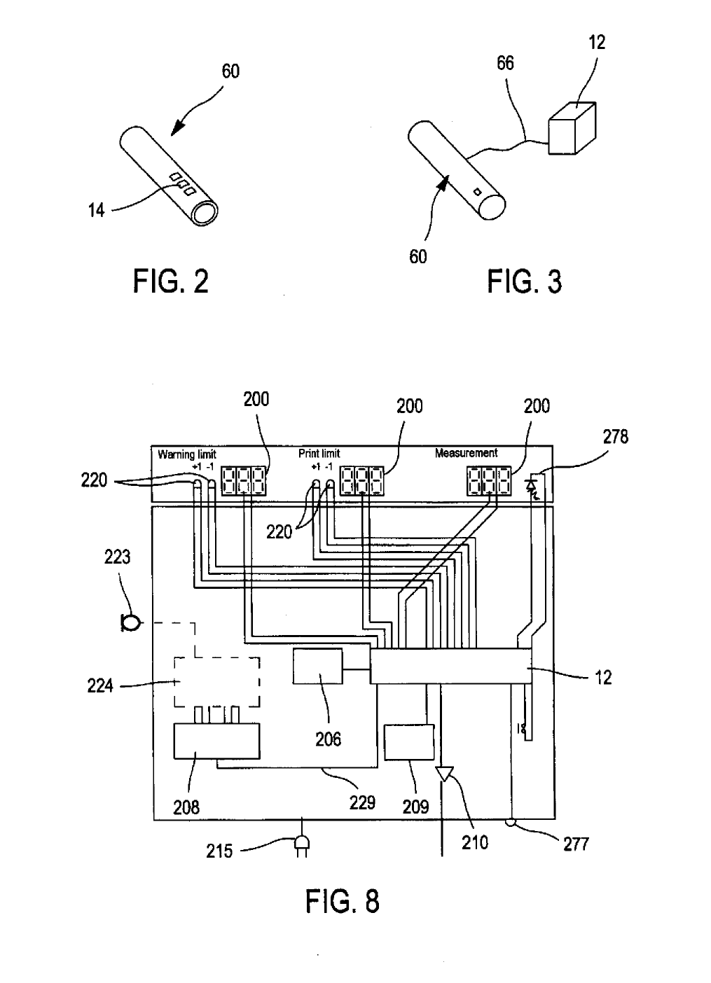

The apparatus may be in the form of a handpiece 60, as shown in FIG. 2, or a handpiece 60 that is connected by a wired or wireless connection 66 to a base station, as shown in FIG. 3. The base station may include the processor unit 12.

The apparatus may be arranged to apply a probe composition, and/or one or more treatment compositions, including one or more makeup compositions. For example, when the apparatus is facing a blemish that it has detected, it may apply one or more compositions, and when it is not facing a blemish, the apparatus need not apply any composition. Detection and application may be performed automatically, with the apparatus optionally requesting confirmation from the user after indicating the presence of a blemish, prior to triggering application.

The apparatus may be moved manually over the skin or the hair, and the apparatus may perform the application of the composition(s).

The apparatus may include or communicate with a data storage system serving for example to store data coming from the detection system and/or information relating to the applications that have been performed, together with information that might be input by the user.

By way of example, the storage system comprises optical memories, magnetic memories, hard disks, universal serial bus (USB) keys, electrically-programmable read-only memories (EPROMs), . . . .

The data storage system may be useful for making comparisons. For example, the method of the invention may comprise making at least one comparison between two detections carried out at different moments, e.g. for the purpose of determining how a blemish or a treated region is changing.

The interface may comprise a screen, one or more displays, a mouse, buttons, a keyboard, a system for synthesizing and/or recognizing voice. Where appropriate, the interface may also enable data to be exchange with another, similar appliance, via a wired or wireless connection, e.g. a radio frequency (RF) or an infrared (IR) connection, or with a server, e.g. by means of a computer network, e.g. the Internet. The data that is exchanged may relate to the results of detection or to the applications that have been carried out.

The method of the invention may comprise downloading a program from a server into the processor unit for the purposes of processing data coming from the detection system and of controlling the application system, e.g. for individual personalization purposes or for loading a program that is designed for some specific type of skin, age, sex, . . . .

The method of the invention may also comprise sending data from the detection system to a remote server, e.g. over the Internet, and of receiving data in return for the purpose of controlling the application system. This may make it possible to enable an expert system or an expert to become involved or to take advantage of the latest novelties in terms of data processing.

The method of the invention may comprise comparing data from the detection system, e.g. in order to determine how blemishes that have been found change over time, comparing the number of blemishes, their locations, the speed with which they disappear, or fail to disappear, so as to refine treatments and establish communication with people suffering from the same blemishes or treatment problems. If the device determines that the blemishes are disappearing more quickly than that which is normally observed, it may for example reduce dosage or propose spacing out applications, and vice versa.

### Detection System

The detection system may be optical and/or non-optical, being adapted to the probe composition and to the way in which it interacts with keratinous material.

Detection may be performed remotely, with or without contact between the detection system and the keratinous material.

With optical detection, the detection system may be arranged to illuminate the observed zone using visible light, ultraviolet (UV) light, and/or IR light, for example in order to excite fluorescence.

When detecting roughnesses, the detection system may be arranged to rub against the skin, and for example to measure a portion in relief, a force, or a rubbing noise.

The detection system may also have no means for contacting the zone in which detection is being performed, e.g. serving to measure temperature.

Detection of a probe composition may be performed with the help of one or more sensors.

A single sensor of the detection system may serve to a detect a plurality of different probe compounds. Thus, the skin may be illuminated with UV light and a plurality of different fluorescent wavelengths may be detected, associated with respective probe compounds.

The detection system may thus include one or more sensors operating in on/off mode or responding to different intensities.

The detection system may include one or more polarizing filters, diffraction gratings, lenses, microphones, Hall effect sensors, inductive sensors, amplifiers, or other electronic components. A diffraction grating may be useful with a plurality of probe compounds of colors that are different but rather close together, in order to separate colors during detection.

The detection system may be arranged to perform one or more measurements of at least one characteristic of keratinous material, independently of using the probe composition, for example to measure color or gloss. By way of example, the detection system may measure the color of the skin and this measurement may be useful for printing on the detected blemish(es) using a color that is the same as that of the surrounding skin.

In an implementation of the invention, detection takes place at a resolution that is better than at millimeter scale, thus enabling microscopic blemishes to be detected. The detection system may include a magnifying optical system, for example.

The detection system includes for example one or more linear optical sensors or a matrix optical sensor, e.g. of the CCD, CMOS, EMCCD, or focal plane array (FPA) type, or an amplified camera that includes an optical amplifier, e.g. of the microchannel wafer type.

By way of example, the detection system may have one detection cell per centimeter to 10,000 detection cells per centimeter.

By way of example, it is possible to use a linear or matrix sensor having 16 to 2500 detection cells per centimeter, e.g. a linear sensor as used by the supplier E2V in cameras referenced Eliixa UC 8, or those from the supplier Dalsa and referenced ILC6.

When the detection system is made in such a manner as to measure a color, the detection system may include one or more sensors that are responsive to white light and a plurality of light sources at different colors that are suitable for being switched on sequentially.

The detection system may also include at least one sensor that is responsive to a respective color component, e.g. a plurality of sensors responsive to respective different color components. The detection system may for example comprise a plurality of linear sensors, e.g. three linear sensors, each having 16 to 4096 detection cells per linear sensor, with each of the linear sensors possibly being associated with a given color filter.

The detection system may include at least one contact sensor, operating by friction or by temperature, e.g. a linear sensor or a matrix sensor responsive to IR, e.g. a linear sensor of the kind used in Eliixa UC8-NIR (E2V) cameras that include not only rows of R, G, and B detection cells, but also a row of detection cells that are responsive to the near infrared (800 nanometers (nm) to 1100 nm).

The detection system may also include electrodes, for measuring electrical conductivity, for example.

The detection system may be arranged to perform light measurement under visible illumination or under UV or IR illumination. The detection system may be arranged to perform an optical measurement or a non-optical measurement, e.g. a measurement of noise, voltage, temperature, force, . . . .

### Data Processing

The data coming from the detection system may be subjected to processing, which processing may involve comparing received data with at least one threshold, e.g. with at least one tolerance zone.

The analysis methods may rely on multi-parameter comparisons, and in particular the tolerance zones for each parameter may depend on the values of other parameters. For example, tolerance on the skin-porosity parameter may depend on the measured color.

Amongst the various mathematical processes that may be applied, mention can be made of three-dimensional (3D) reconstruction processing, in particular for processing information obtained in depth, and two-dimensional (2D) and one-dimensional (1D) reconstruction processing, e.g. for processing information obtained from a surface.

For example, when blemish detection is performed by mechanical engagement, the data coming from the detection system may be in the form of a set of points detected on a surface, corresponding to as many detected particles of probe compound. By way of example, these particles may be fluorescent and they may be detected optically. The particles may be sticky and fluorescent. The processing implemented may include a step that consists in searching for points in alignment, and in identifying wrinkles as being the points that form straight or curved lines. Processing may be performed not only at points where particles are detected, but also between points where particles are detected, along zones that are determined by interpolation.

Another possible form of processing is processing to match with skin blemishes that are common, e.g. by comparing detected blemishes with libraries of common blemishes. Thus, when there is uncertainty in 1D reconstruction of wrinkles, e.g. between lines that are vertical and lines that are horizontal, the matching processing may serve to remove ambiguity and enable only horizontal lines to be retained when reconstructing wrinkles.

### Application System

Detection of a blemish may be followed by application of a composition seeking to treat the blemishes and/or to camouflage it. Application may be performed on all the blemishes that are detected, or on a fraction only of them.

Application may be performed over the entire area of each blemish, or over a portion of its area only. Preferably, application does not exceed the extent of the blemish as detected.

The treatment need not be uniform over the entire area on which detection has been performed, subjected to detection, for example treatment may be limited to an application that covers detected blemishes only.

Any technology may be used for the application system, and in particular printing technologies.

Mention may be made in particular of offset printing, photogravure, flexography, silk-screen printing, pad printing, electrophotography (also known as xerography, electrostatic printing, or laser printing), thermal printing (including in particular simple thermal printing, thermal transfer printing, or thermal sublimation printing), elcography, toner jet, magnetography, ionography (also known as ion jet electron beam imaging, or electrography), and ink jet printing (including in particular so-called “continuous ink jet” and “drop on demand” technologies).

Ink can be ejected as a jet or as droplets by a piezoelectric element, by a thermal element (bubble jet), by hot-melting, or by means of a valve (valve jet).

Mention may also be made of impact printing techniques, such as for example hammer or chain printing, needle or dot matrix printing, daisy wheel printing, thimble printing, and techniques such as minispray, gas printing, compressed air printing, liquefied gas printing, fluidized pressure printing, such as for example airbrushes or minisprays obtained by a moving part, e.g. a moving piezoelectric crystal.

It is also possible to use an application system comprising a movable application element such as a sponge, a felt, a paint brush, a hollow tube, or a syringe, containing the composition for application, e.g. an ink, which composition is put into contact with the hair or the skin for application. The duration of contact may be adjustable and vary for example over the range 1/1000th of a second (s) to a few seconds.

The term “printing” is generally used to mean delivering the composition to the surface of the material for treatment, in particular the skin. In the meaning of the invention, printing relates to delivering the composition onto or beneath the surface for treatment. Thus, printer means using needle printing technology can enable the ink to penetrate into the stratum corneum, the epidermis, or the dermis. For this purpose, it is possible to use strong needles or brittle needles, or the like.

The application system may have a single print nozzle or a plurality of print nozzles disposed in parallel.

The application system may include nozzles that are dedicated to respective compositions, or in a variant a single nozzle may inject a plurality of different compositions in succession or mixed together while printing is taking place so as to create the color for printing and/or the desired mixture of active agents.

The application system may be spaced apart from the skin or the hair in order to avoid direct contact with keratinous material. This spacing may be fixed or adjustable. The spacing may be adjusted either directly, e.g. by turning a knob or by actuating an adjustment button that controls the movement of a motor, or else it may be performed automatically. When performed automatically, the processor unit may control a motor to change the spacing.

If it is desired to perform printing that is sharp, it is possible to adjust the spacing to a short distance, e.g. one millimeter or less, and conversely, if it is desired to perform fuzzier printing, it is possible to adjust the spacing to a longer distance, e.g. 1 cm or more.

The application system may include a print head capable of printing over the entire surface for treatment. By way of example, this print head includes one or more nozzles for ejecting composition. Assuming that the user moves the apparatus including the application system along an axis X, then the print head is, for example, oriented perpendicularly to the axis X along which the apparatus is moved.

The print head may be stationary within the apparatus or it may be movable along an axis Y that is perpendicular to the axis X. By way of example, the apparatus causes the print head to perform Y scanning, with or without printing during carriage returns. The carriage may be driven by stepper motors, e.g. motors that are addressed directly by a USB port.

When the apparatus includes a plurality of print heads that are stationary within the handpiece, the print heads may optionally be in alignment, e.g. they may be in a staggered configuration.

The apparatus may include an application system having at least one print head capable of moving relative to the above-mentioned carriage along a Z axis that is perpendicular to the X and Y axes.

The print head may be actuated mechanically during printing, e.g. by a vibrator, in order to obtain a fuzzy effect.

The apparatus may include a vacuum or blower system for accelerating drying, and/or a heater system.

When the composition deposited on the keratinous material requires exposure to light radiation, e.g. to UV radiation, in order to polymerize it, the apparatus may include a corresponding lighting system to assist the polymerization.

The application system may include a print line made up of a plurality of printer elements disposed along a print line. The printer elements may for example be nozzles that enable the color that is to be printed locally to be created at the time of printing.

Printing may take place by depositing a plurality of compositions in juxtaposed manner or in a manner in which they are superposed at least in part. The deposited dots of various compositions may be of the same size or of different sizes.

The treated surface may be covered entirely by the composition(s), or spaces may remain between the deposits of composition. The compositions may be deposited in a silk-screen configuration.

When an image is printed on keratinous material, the image need not be uniform, i.e. the printing may make use of at least one ink that is deposited in non-uniform manner over the surface for treatment.

The apparatus may include a monitoring system enabling the user or the apparatus to determine whether printing is satisfactory or whether printing should be continued or corrected. By way of example, the monitoring system may use the detection system or it may include a specific camera or other sensor. For example, the apparatus may display the keratinous material undergoing treatment on a screen. Although hidden by the apparatus, the keratinous material appears to the user on the screen, and the user can then assess the application that is taking place.

Since the movement of the apparatus is not necessarily rectilinear, provision may be made for treatments to be “point-to-point” rather than “line-to-line”, so that printing takes place in a manner that is identified relative to the keratinous material, even if the path followed by the apparatus is curved.

The application system may apply a cosmetic ink. The inks used are adapted firstly to printer technology, and secondly to the desired color. The inks used are preferably fluid and they may be water-based or they may be based on organic solvents and they may include at least one coloring agent selected from natural and artificial dyes that may optionally be fluorescent or phosphorescent, organic and/or inorganic pigments, and mixtures thereof. The ink may include one or more non-colored materials that achieve optical effects, such as a fuzzy effect, for example. Where appropriate, one of the applied compositions may be a base coat or a top coat in order to improve ink retention, for example. The applied coloring agent(s) and/or non-colored agents that are optically active may be in a dispersion, dissolved, or in an emulsion. They may also form a mixture that is not very stable, which may then be remixed or redispersed at the time of use. By way of example, inks are placed in a cartridge or a group of cartridges that can easily be removed and replaced.

It is possible to use the application system with one or more cartridges of colored ink, e.g. corresponding to primary colors, cyan, magenta, yellow, black, or to colors that are close to skin color (pink, ochre, beige, ivory, brown, . . . ).

In an implementation of the invention, a single print nozzle is used together with a plurality of cartridges of inks having predefined colors. For example, there may be 1 to 1000 colored inks, e.g. 16, representing a set of colors usually to be found on the skin: pale beige, yellowy beige, pinky beige, . . . . All of the cartridges are connected to the print nozzle and the apparatus modulates the flow rate to the print nozzle from each of the cartridges as a function of the color that is to be printed, e.g. using electrostatic microfluidic technology.

The apparatus may be arranged to create portions in relief on the keratinous material with the help of a photopolymerizable material. The techniques used are 2D or 3D laser polymerization, for example. Depending on the delivered light energy, polymerization takes place to a greater or lesser depth. Femto lasers that deliver very high peak powers, and that thus make so-called bi-photonic polymerization possible, are most suitable, but other optionally pulsed lasers could be used. It is possible to perform photopolymerization in focal planes.

### Application of a Composition Having a Color Matching a Skin Color

The application system may apply a composition having a color that has been selected to match a skin color, even where the composition is obtained by mixing of components of different colors outside the apparatus.

The application of the composition may be useful to camouflage the blemishes.

For example, the handpiece may send data related to the color of the skin to a mixing unit. The mixing unit may mix two or more components to obtain a mixture having a color that matches the color of the skin. In some embodiments, the user may use an independent mixing unit, that is configured to analyse the skin and to mix at least two components to produce a mixture having a color which matches the analyzed skin. The mixing unit may be used at, e.g., home, a point of sale, or at any suitable location.

In other embodiments, the handpiece may send data relating to the color of the skin to a decision unit. The decision unit may be located remotely and may be configured to identify, e.g., from a library of products, a product having a color that matches the color of the skin.

In other embodiments, the user uses a decision unit. The decision unit is capable of analyzing the skin, to identify, e.g., in a library, a product having a color that matches the color of the skin. The mixing unit may be used, e.g., at home, at a point of sale, or at any suitable location.

The user may load a composition in the handpiece. The user may also load a product at a plurality of times throughout a particularly time frame (e.g., monthly, weekly, daily, (many times a year), to adapt the color of the composition to natural variations of skin color at various times during the time period, and to the ambient light at different times (e.g., of the year) among other things.

The user may load one or more compositions in the handpiece. The latter may, analyse the color of the skin, either at each use of the device and/or on a regular basis (e.g., not each time the device is used). The device may automatically select the product to be used or alert the user that the user may load a specific product into the device. The device may store (e.g., in a memory) data that will allow identification of a product that matches at least one color of skin or may have access to a memory that will allow such an identification.

In some embodiments, a color of the skin is measured at a time t and products are made having colors corresponding to the colors that are expected during a time Δt (e.g., during the year) for an individual. The products may be made by mixing components of various colors (e.g., by the user himself by identifying the products in a library of products) or by other suitable methods. The range of products and corresponding colors may be determined by software that computes the evolution of skin color according to personal data and/or general data. For example, if the skin color is measured in winter, one may make a plurality of products, for example four products, one product corresponding to the skin color as measured, and the other products corresponding to expected colors at spring, summer, and autumn. Notably, any suitable time period may be used, and use of the seasons is intended as exemplary only.

The software may utilize, for example, statistical rules of evolution of the color of different categories of skin during the year for making such determinations related to colors.

The software may also take into account personal factors such as for example, the user's surroundings, a user's life style a habits, the places and dates of holidays/vacations and other suitable factor.

In some embodiments, the software may take into account weather data such as sun exposure.

The device may, by analyzing the color of the skin, either at each use or on a regular basis but not necessarily at each use, select a product and use this product, or it may alert the user that he may load a specific product. The device may store in a memory or have access to a memory that will allow identification of the product that matches or is a closest match to the color of the skin. The device may comprise a timer that provides information relating to particular time periods (e.g., calendar dates) and may facilitate selection of the product to use.

The software may comprise a learning system that may enable improvements in the predictions.

One may pre-set the color of the composition. One may set, in a precise manner the color later, using the preselect color and adding to such preselect color, additional color components. The first setting may be done at for example, a store and the later setting may be made at, for example, home, either in the device itself or outside the device.

It may be possible to identify a color that matches the color of the skin and to make or select at least two products having colors that are different from the current matching color with for example the current color of the skin between them.

### Treatment of Keratinous Material

After detecting one or more blemishes, said blemish(es) may be treated in localized manner by applying a composition thereon, e.g. one or more inks, a care product, a moisturizer, a slimming agent, a sunscreen, a colorant, a masking agent, a cleaning and washing composition, an activator or inhibitor composition, an antibacterial agent, a fragrance, an antiperspirant, or a waterproof composition.

The treatment may include applying a composition for encouraging or enabling the action of a composition that is to be applied subsequently, for example a catalyst, a reagent, a composition for achieving penetration, a composition for preventing penetration, an adhesive, an anti-adhesive, a composition assisting absorption, a composition preventing absorption, . . . .

The treatment performed on the blemish(es) may also be localized physical treatment, e.g. heating, exposure to light radiation, to cold, to ultrasound, to radiofrequency radiation, to electricity, . . . . When the treatment is light treatment, the light may be focused, for example. In order to enable treatment involving electricity to be performed, or the application of low or high temperatures, it is possible to use one or more electrodes and a temperature probe of small dimensions.

Before the treatment takes place, the apparatus may suggest to the user that a particular active agent should be used or that said active agent should be used at a particular dosage.

The apparatus may make such a treatment proposal as a function of information input by the user, e.g. a preference expressed by the user concerning the form and/or the formulation, e.g. a more or less greasy texture, colored or not colored, with or without fragrance, or a desire to mask blemishes quickly or not so quickly, . . . .

The method of the invention may include requiring information relating to the general state of the user, e.g. sensations of irritation (itching).

### PROPOSED EXAMPLES

### Example 1

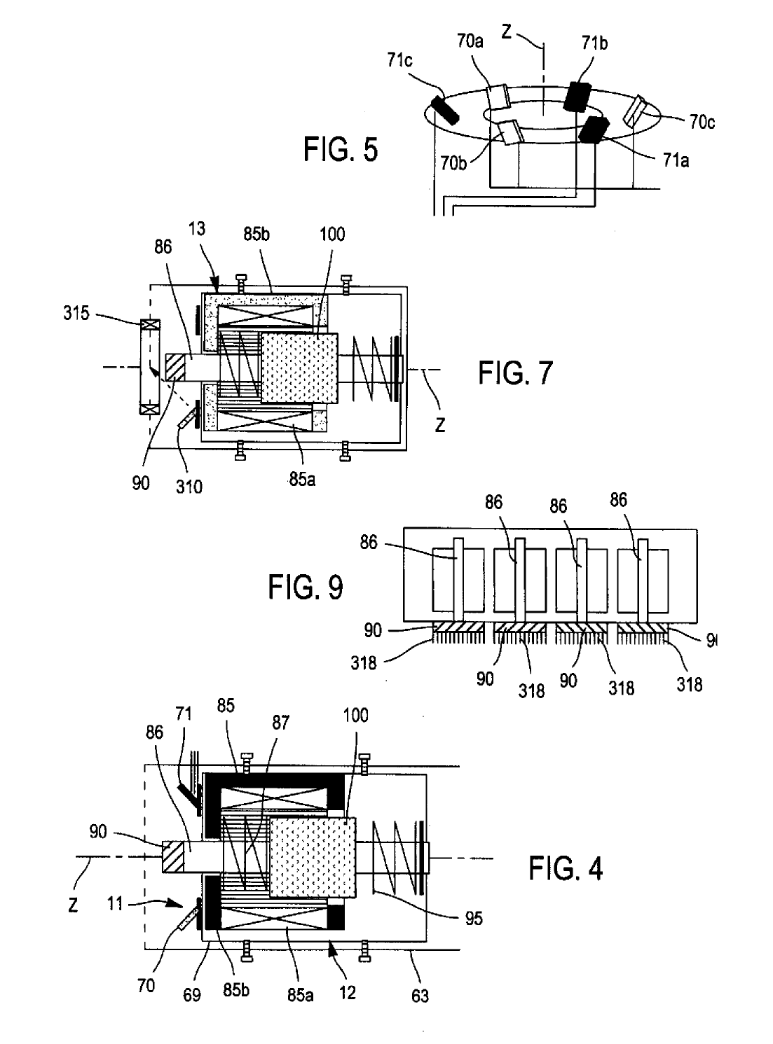

In this example, the application system is configured to apply a composition by making contact with the keratinous material, as shown in FIG. 4. As shown in this figure, the application system may comprise a casing 69 that is stationary relative to a housing 63 of the handpiece, and it may receive therein an electromagnet 85 enabling a movable portion 86 to be moved along a Z axis against return action from a resilient return member 87. This member limits stroke and attenuates movement so as to avoid any sudden impact against the skin.

The movable portion 86 in the example shown carries an applicator member 90 that is designed to come into contact with keratinous material when the electromagnet 85 is electrically excited.

When excitation of the electromagnet 85 ceases, the resilient return member 87 returns the movable portion 86 rearwards.

To adapt the return movement of the movable portion 86, the application system may include a damper member 95, e.g. in the form of a resilient return member that is compressed when the rearward movement of the movable portion 86 exceeds a predefined stroke.

As shown, the movable portion 86 may include a tank 100 containing the composition for application on the keratinous material, communicating with the application member 90.

By way of example, the tank 100 is made of plastics material, being open at its end and terminated by a felt tip that constitutes the applicator member 90. The felt tip, which is porous, communicates with the tank. Thus, the composition contained in the tank can migrate by capillarity into the felt tip. Other applicator members 90 could be used.

By way of example, the movable portion 86 is made magnetic by a ring made of iron, e.g. having a length of about 2 cm. The tank 100 may be adhesively bonded to the ring.

The winding 85a of the electromagnet may be contained for example in a part 85b that is made of a U-shaped piece of soft iron with a hole in its middle. A U-shape has the advantage of concentrating the magnetic field created by the coil in its center, thereby attracting the movable portion, moving it to the left in FIG. 4.

As shown in FIG. 6, a circuit may be incorporated in the apparatus, e.g. in the handpiece or a base station with which the handpiece exchanges data, the circuit comprising six pushbuttons 220 and three liquid crystal displays 200 that are connected via a connection, e.g. a serial connection, to the processor unit 12 which comprises for example a programmable logic array, e.g. that referenced Cyclone III EPC 3 from the supplier Altera.

The apparatus may include a memory 206 for the processor unit 12, e.g. a memory of the EPROM type, an analog-to-digital converter 208, an oscillator 209 operating at 24 MHz, for example, an amplifier module 210, a current supply 213, and a general power supply 215. On being switched on, the program that controls the operation of the processor unit 12 is loaded from the memory 206.

As shown in FIG. 6, the apparatus may also include an on/off button 277 and a lamp 278 informing the user that an out-of-tolerance zone has been detected.

As shown in FIG. 5, the detection system may comprise a LED 70a emitting white light and two UV LEDs 70b and 70c, e.g. of the trademark HERO, having the reference HULV 370-510 and emitting at a wavelength around 370 nm. A photodetector 71a, e.g. of the C30807 type, associated with a red filter, is placed facing the LED that emits white light. Two photodetectors 71b and 71c, e.g. of the C30807 type, with respective red and green filters are placed facing the two UV LEDs 70b and 70c.

As photodetectors, the LEDs are oriented by way of example at 45° towards the center so as to look at the surface facing the detection system, e.g. at a depth of about one-and-a-half centimeters.

The LEDs may be provided with lenses for focusing light in said direction and they may also be provided with a small amount of protection to prevent light from directly irradiating towards the photoreceivers.

The current supply 213 feeds the LEDs 70a to 70c of the detection system.

The three photoreceivers 71a to 71c are connected to an analog-to-digital converter 208.

By way of example, the analog-to-digital converter 208 is an AD7794 converter having six inputs from the supplier Analog Device, that incorporates a 6-input analog multiplexer, with only three of the inputs and an output of the converter being used.

The power amplifier 210 includes for example an operational amplifier and a power stage made up of power transistors, suitable for generating currents of several amps, in order to enable the movable portion 86 carrying the applicator member 90 to be set into motion.

Detection may be inactivated during application. For example, data from the detection system may be set to zero and the processor unit may be programmed to cancel application when the values reaching it are zero. The handpiece may be provided with a button for inactivating activation and/or detection, in particular a button close to the location on which the fingers are placed, with use of the button having the consequence of sending a measured value of zero to the processor unit, for example.

By way of example, the processor unit 12 is configured to accomplish the following functions:

1) capture from the six adjustment buttons 220. Each button serves to vary an 8-bit register, either by incrementing it or by decrementing it, with this applying to the three registers Rₜₕᵣₑₛₕ, FluoRₜₕᵣₑₛₕ, and FluoGₜₕᵣₑₛₕ in the example described;

2) sending the values of the three registers Rₜₕᵣₑₛₕ, FluoRₜₕᵣₑₛₕ, and FluoGₜₕᵣₑₛₕ to the displays 200. By way of example, sending takes place over a serial link in the form of ASCII code;

3) controlling the converter 208 which continuously receives analog data via the connections 279 coming from three photoreceivers 71a to 71c and sequentially transforms the analog data, e.g. at the rate of 100 hertz (Hz) into digital values R_{measured}, FluoR_{measured}, and FluoG_{measured}, in the form of numbers encoded on 16 bits, for example;

4) digital capture from the converter 208, received over a connection 230, e.g. of the serial type;

5) where necessary, converting the components R_{measured}, FluoR_{measured}, and FluoG_{measured} from 16 bits to 8 bits, for example; and

6) comparison operations, i.e. for example:

R_{measured} is compared with Rₜₕᵣₑₛₕ, FluoR_{measured} is compared with FluoRₜₕᵣₑₛₕ, and FluoG_{measured} is compared with FluoGₜₕᵣₑₛₕ, as follows:
if R_{measured}<Rₜₕᵣₑₛₕ AND FluoR_{measured}<FluoRₜₕᵣₑₛₕ AND FluoG_{measured}<FluoGₜₕᵣₑₛₕ, the processor unit does not produce any print instruction;
if R_{measured}≧Rₜₕᵣₑₛₕ OR FluoR_{measured} FluoRₜₕᵣₑₛₕ OR FluoG_{measured} FluoGₜₕᵣₑₛₕ, printing is triggered and an indicator light 278 is switched on; and
if R_{measured}=0 AND FluoR_{measured}=0 AND FluoG_{measured}=0, then the processor unit does not produce any print instruction, regardless of the results of the other operations.

By way of example, the probe composition is a solution of ABDF in water and alcohol (70% water, 30% ethanol, by weight) together with 0.1% of C8632 (2-(2-(4-dimethylaminophenyl) vinyl-ethypryidinium ethyl sulfate, percentages being by weight.

Once the solution is dry, e.g. after waiting for 5 minutes, the skin is rinsed and allowed to dry, and the apparatus is applied to the skin and moved over the entire area to which the probe composition has been applied.

The thresholds Rₜₕᵣₑₛₕ/FluoRₜₕᵣₑₛₕ, and FluoGₜₕᵣₑₛₕ are set so that when the signal delivered by the photodetector 71a facing the LED 70a emitting white light exceeds the level Rₜₕᵣₑₛₕ/then printing is triggered.

Thus, the apparatus is capable of treating blemishes constituted by zones that are pinkish or made reddish by irritation or by a little local infection. The tank 100 may contain a masking composition, e.g. based on ochre pigments, and/or a disinfectant, e.g. a mixture of ethanol and water, which composition is therefore applied in places where blemishes are detected.

When the signal FluoR_{measured} from the photodetector 71b provided with the red filter facing the UV LED 70b exceeds the level FluoRₜₕᵣₑₛₕ, printing is triggered. Thus, the apparatus is capable of treating zones that have been made anionic by excess oxidation. The tank 100 may contain a cationic composition, e.g. including a cationic surface-active agent at 4% by weight, a fatty alcohol at 6%, and water.

When the value FluoG_{measured} from the photodetector 71c with the green filter facing the corresponding UV LED 70c exceeds FluoGₜₕᵣₑₛₕ, then printing is triggered. The apparatus is thus capable of treating zones that have been made rich in cysteine by excess glutathione activity. The tank may then contain an oxidizer, e.g. 2% by weight of benzoil peroxide in water.

In general, the user may fill the tank 100 with a composition that is selected as a function of the detection being performed.

In a variant, the apparatus may have a plurality of tanks and the user may select the composition for application, e.g. by acting on a selector that controls a microfluidic system. In a variant, the apparatus has applicator heads that are specific to the various compositions used.

More generally, other apparatuses may be used for treating zones that have been made anionic by excess oxidation or zones that have been rich in cysteine by excess glutathione activity.

### Example 2

The apparatus of Example 1 is modified so as to be adapted to use on keratinous fibers, by providing it with a comb that enables hairs to be guided while also causing them to pass in front of the detection system.

The fibers may be treated with the same probe composition as in Example 1, containing C8632.

Each time it detects a blemish, e.g. when the signal FluoR_{measured} from the photodetector 71b with the red filter placed facing the UV LED 70b exceeds the threshold, the apparatus may apply a polymerizable compound, e.g. methylheptylcyanoacrylate in a silicone oil. Polymerization takes place on drying with an effect that is gentle and long-lasting. In general, other apparatuses may be used for applying a polymerizable compound.

### Example 3

The apparatus includes a microphone for sensing noise representative of rubbing against the skin.

The device may be made for example with an electronic circuit as shown in FIG. 8 and with the application system of FIG. 7.

A microphone 310 may be fastened to the casing 69 as shown in FIG. 7, the microphone 310 being constituted for example by a unidirectional microphone of the kind sold by the supplier Projects Unlimited, under the reference PUM 3546L-R.

It is also possible to fasten a ring 315, e.g. a PTFE ring, to the front of the handpiece. This ring 315 comes into contact with the skin and creates a noise if the skin is rough. It allows the movable portion 86 of the print head to pass through its center.

In this example, the processor unit 12 performs several functions:

1) capture from the four adjustment buttons 220. Each button 220 causes a register to advance either by incrementing it or by decrementing it, e.g. a register encoded on 8 bits, with this applying to two registers that are referenced Sₗᵢₘᵢₜ and S_{action};

2) controlling the converter 208 that continuously receives analog data from the microphone 310, via an operational amplifier 224, e.g. of the kind sold by the supplier Analog Device under the reference OP27GSZ. It transforms the analog data concerning sound volume sequentially and at a rate of 100 Hz into digital values in the form of numbers encoded on 16 bits;

3) digital capture from the converter 208 as received via a serial link 229, e.g. a link of the serial peripheral interface (SPI) type;

4) converting the numerical value for sound volume from 16 bits to 8 bits and storing it a register referred to as S_{measured}; and

5) delivering the values of the three registers Sₘᵢₙ, Sₘₐₓ, and S_{measured} to the three displays 200; this is performed for example over a serial link and in ASCII code form.

Comparison operations may be performed by the processor unit 12, and specifically S_{measured} may be compared with Sₗᵢₘᵢₜ and S_{action} as follows:
if S_{measured}>S_{action}, then the processor unit instructs printing with pulses of duration d₁, e.g. 1/20th of a second; and
if S_{measured}>Sₗᵢₘᵢₜ, the processor unit causes an indicator light 278 present on the handpiece to be switched on.

The processor unit can thus adjust the duration of the pulse delivered if the result of the logical operations allow for printing. Two print durations d₁ and d₂ may be provided, e.g. equal to 1/20 s and ⅕ s, respectively.

During printing, i.e. while the movable portion is advancing towards the skin, capture from the microphone is disconnected. The apparatus should not be activated by the noise it makes.

The probe composition is formed in two stages by applying an adhesive base and then by applying particles on the adhesive base.

The base comprising for example 3% by weight of adhesive particles (Gel-Tac from the American supplier API) is applied to the skin and then this composition is rubbed on the skin until it has dried, taking care to avoid causing particles to cluster by rubbing too hard.

Thereafter, silica particles are dusted onto the previously treated zone and the apparatus is moved over the skin.

By way of example, the tank 100 contains a composition that can be polymerized, e.g. a reactive silicone from the supplier Dow Corning that is applied as soon as the apparatus detects significant rubbing where S_{measured}>S_{action}, i.e. preferably on zones having portions in relief such as wrinkles.

In general, other apparatuses may be used for applying a polymerizable composition.

### Example 4

In this example, the apparatus has four print heads, e.g. disposed side by side as shown in FIG. 9, each having a width of 2.5 cm, for example, and being spaced apart by 0.5 cm, for example.

The applicator members 90 of the various heads are wider than the associated tanks, for example.

The ring 315 in the example of FIG. 7 is replaced by four sets of teeth 318, each tooth having a width of 1.2 mm and a length of 1 cm, for example, with two consecutive teeth being spaced apart by 1.2 mm, for example. The teeth have rounded ends, for example. Each set of teeth 318 has a length of 2.5 cm, for example.

The sets of teeth 318 are placed ahead of the applicator members 90 in the travel direction of the handpiece, e.g. 5 mm ahead, and they are fastened to the rear face of the handpiece by a material that absorbs vibration, e.g. an elastomer gasket, e.g. made of silicone.

The four unidirectional microphones are placed close to the sets of teeth 318, facing the skin.

The four print heads may be actuated independently of one another by the base station.

The four corresponding tanks are filled with a care product, e.g. 2% by weight of a silicone/amine in a 80:20 mixture of water and ethanol.

The probe composition is formed by successively applying two solutions. A first solution comprising 6% ammonium carbonate with pH 8.5 is applied on the hair. Thereafter a second solution is applied containing 6% potassium bromate with pH 7.5.

After drying, the hair is rinsed and dried using a hair dryer and the apparatus is placed on the hair to sweep along the hair lengthwise.

Each of the tanks contains a polymerizable composition, e.g. a reactive silicone from Dow Corning, which composition is applied as soon as the apparatus detects a high level of rubbing, i.e. preferably in zones that are damaged.

### Example 5

A probe composition including a fluorescent agent mixed with a compound that is designed to be subjected to wear, e.g. a waxy compound or a polymer film or an oil is deposited on the skin or the hair, and zones are detected where the compound has disappeared, e.g. by optical detection. Treatment may be performed where the probe composition reveals wear.

### Example 6

A polymer film containing a fluorescent compound, e.g. a film based on Mexomer resin (from the supplier Chimex), at 5% dissolved in ethanol is deposited on the skin. The fluorescent compound is for example the compound UVXPBR (from the supplier LDP-LLC, Carlstadt, N.J., USA). After drying, the film becomes worn in use after a few hours.

The apparatus detects fluorescence by excitation with black light and by capturing light in the red zone.

It considers that zones that have lost fluorescence have been zones that are likely to have been attacked, scratched, abraded, . . . . It applies a care product on those zones (oil, moisturizer).

### Example 7

Cosmetic treatment is performed in this example that consists in illuminating sweat glands or their surroundings with a light beam, e.g. at a wavelength of 870 nm, so as to reduce their activity.

A dye is used that reveals a compound present in sweat, e.g. a protein such as ninhydrine. Marks that can be made visible by UV light are detected by the detection system, which system includes for example a camera and an image analyzer program.

The light radiation is then directed towards the zones that have been revealed by the dye, using a scanning and illumination control system.

The term “comprising a” should be understood as being synchronous with “comprising at least one”.

1. A non-therapeutic method of cosmetically treating human keratinous material, the method comprising:
applying to said keratinous material a probe composition suitable for interacting in predefined manner with the keratinous material;
using an apparatus to detect automatically any interactions between the probe composition and the keratinous material; and
automatically performing cosmetic treatment on the keratinous material as a function of the manner in which the probe composition has interacted.

2. A method according to claim 1, including automatically detecting one or more locations where the probe composition has interacted.

3. A method according to claim 2, detection taking place optically.

4. A method according to claim 1, including automatic treatment of the location(s) where the probe composition has revealed at least one blemish.

5. A method according to claim 4, the treatment including applying a cosmetic composition on the blemish(es).

6. A method according to claim 5, the composition having a color matching a color of the keratinous material.

7. A method according to claim 1, the probe composition interacting chemically with the keratinous material.

8. A method according to claim 1, the probe composition including at least one fluorescent probe compound.

9. An assembly comprising:
a probe composition for application to human keratinous material, and suitable for interacting in predefined manner with said keratinous material; and
apparatus for bringing into contact with or into the proximity of keratinous material where the composition has been applied, the apparatus including a detection system suitable for detecting the location(s) where the probe composition has interacted in predefined manner with the keratinous material,
the apparatus being configured to treat the keratinous material automatically as a function of the detection performed thereby.

10. An assembly according to claim 9, the apparatus including an application system for automatically applying a composition where the apparatus has detected the presence of a blemish revealed by the probe composition.

11. An assembly according to claim 10, the application system including an ink jet or minispray print head.

12. An assembly according to claim 10, the application system including an applicator member that comes into contact with the keratinous material.

13. An assembly according to claim 9, the apparatus including an interface enabling the treatment-triggering threshold to be adjusted.

14. An assembly according to claim 9, the apparatus including a handpiece including the detection system.

15. An assembly according to claim 9, the special resolution of detection better than 1 cm, in at least one direction.
